(19) United States
(12) Patent Application Publication
(10) Pub. No.: US 2005/0093213 A1
(43) Pub. Date: May 5, 2005

(54) Air damper of vehicle glove compartment

(75) Inventor: Pil-Sik Jang, Ulsan Metropolitan City (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 10/974,128

(22) Filed: Oct. 26, 2004

(30) Foreign Application Priority Data
Oct. 31, 2003 (KR) 10-2003-0076720

(51) Int. Cl. F16F 5/00

(52) U.S. Cl. 267/120; 188/281; 267/124

(57) ABSTRACT

An air damper includes a cylinder having a hole at one end for adjusting air flow, and a piston configured to slide within the piston. One end of a string passes through a hole of the piston and the other end of the string is connected to a cover of a glove compartment, thereby allowing the cover of the glove compartment to smoothly and gently open, contributing to an improvement of the quality of the vehicle.

### CROSS-REFERENCE TO RELATED APPLICATIONS

The present application is based on, and claims priority from, Korean Application Serial Number 10-2003-0076720, filed on Oct. 31, 2003, the disclosure of which is incorporated by reference herein in its entirety.

### FIELD OF THE INVENTION

The present invention relates to an air damper, in particular an air damper connected to a cover of a glove compartment of a vehicle. More particularly, the present invention relates to an air damper that enables a user to smoothly and gently open the glove compartment.

### BACKGROUND OF THE INVENTION

A vehicle glove compartment is generally placed at a lower side of the instrument panel at the front passenger side of the vehicle. If a user releases a locked state of the glove compartment, the cover of the glove compartment pivots downwardly and opens the glove compartment to enable the user to load objects into the glove compartment or remove objects from the glove compartment.

Since the cover is designed to pivot in relation to a hinge positioned at a lower side of the glove compartment, when the locked state is released, the cover pivots downwardly due to gravity, thus opening the glove compartment.

### SUMMARY OF THE INVENTION

The present invention is directed to an air damper, in particular an air damper for connecting to a vehicle glove compartment. In other applications, the air damper can be connected to any suitable support or cover. For example, the air damper could be attached to the cover of any suitable compartment capable of being opened and closed by a user.

An embodiment of the present invention provides an air damper of a vehicle glove compartment that enables a user to smoothly and gently open the cover of the glove compartment, thereby improving the quality of the vehicle.

The air damper of the vehicle glove compartment includes a cylinder having at one end an air adjusting hole. An air adjusting plate is provided to at least partially cover the air adjusting hole, where the air adjusting plate can be shifted between a closed position, in which the air adjusting plate completely blocks the air adjusting hole, and an open position, in which the air adjusting plate is out of engagement with the air adjusting hole. In particular, the air adjusting plate adjusts the opening degree of the air adjusting hole according to the air flow.

A piston is configured to linearly slide in the cylinder, the piston having a through hole at a central portion of the piston. A string is configured to pass through the through hole of the piston, wherein one end of the string includes a head having a larger size than the diameter of the through hole and the other end of the string is connected to the cover of the glove compartment. A spring resiliently supports the piston toward the air adjusting hole.

It is understood that the term “vehicle” or similar term as used herein is inclusive of motor vehicles in general, such as passenger automobiles, buses, trucks, and the like.

Other aspects of the invention are discussed below.

### BRIEF DESCRIPTION OF THE DRAWINGS

For a better understanding of the nature and objects of the present invention, reference should be made to the following detailed description taken in conjunction with the accompanying drawings, in which:

FIG. 1 is a cross-sectional view illustrating the construction of an air damper of a vehicle glove compartment according to an embodiment of the present invention;

FIG. 2 is an enlarged cross-sectional view of the air damper depicted in FIG. 1 illustrating the piston in an extended state abutting the left side of a cylinder of FIG. 1; and

FIG. 3 is a cross-sectional view of a glove compartment incorporating the air damper of a vehicle glove compartment according to an embodiment of the present invention.

### DETAILED DESCRIPTION OF THE PREFERRED EMBODIMENTS

One or more preferred embodiments of the present invention will now be described in detail with reference to the accompanying drawings.

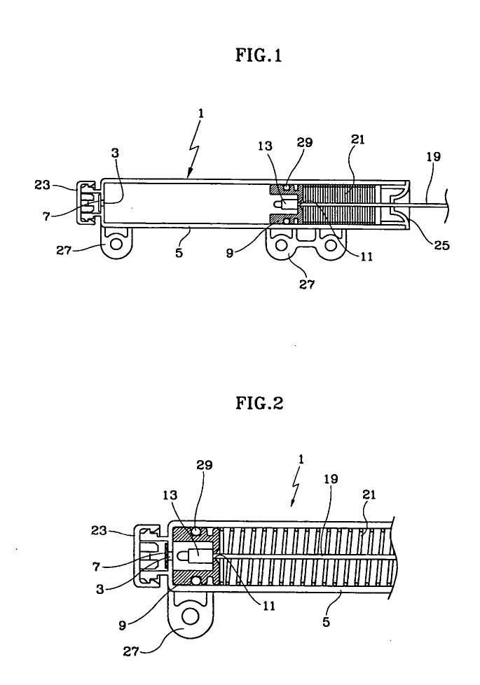

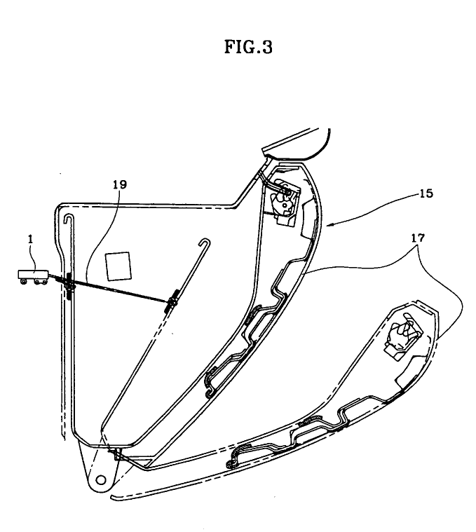

With reference to FIGS. 1 and 3, an air damper 1 according to the present invention includes a cylinder 5 having at one end an air adjusting hole 3. An air adjusting plate 7 is provided to at least partially cover the air adjusting hole 3, where the air adjusting plate 7 can be shifted between a closed position, in which the air adjusting plate 7 completely blocks the air adjusting hole 3, and an open position, in which the air adjusting plate 7 is out of engagement with the air adjusting hole 3. In particular, the air adjusting plate 7 adjusts the opening degree of the air adjusting hole 3 according to the air flow.

A piston 9 is configured to linearly slide in the cylinder 5, the piston 9 having a through hole 11 preferably located at a central portion of the piston, although other locations of the through hole 11 fall within the scope of the invention. A string 19 is configured to pass through the through hole 11 of the piston 9, wherein one end of the string includes a head 13 having a larger size than the diameter of the through hole 11, and the other end of the string is connected to a cover 17 of a glove compartment 15. A spring 21 resiliently supports the piston 9 and biases the piston 9 toward the air adjusting hole 3.

Referring to FIG. 2, one end of the cylinder 5 is provided with a space to allow the air adjusting plate 7 to move within a constant range. An adjusting cap 23 is installed over the air adjusting plate 7 to restrict movement of the air adjusting plate 7 and to prevent the air adjusting plate 7 from separating from the cylinder 5. The air adjusting plate 7 can be made of a material such as rubber or the like.

The other end of the cylinder 5 preferably includes a supporting cap 25 to support the spring 21 within the cylinder 5 and to allow the string 19 to pass through the through hole 11 of the piston 9. The string 19 penetrating the supporting cap 25 can be pulled free from outside the cylinder 5.

A plurality of flanges 27 are integrally formed at various positions on the periphery of the cylinder 5 to fix the cylinder 5 to the main body of the vehicle. For example, at least one flange 27 is positioned at a distal end of the cylinder 5 near the air adjusting hole 3, and one or more flanges 27 can be positioned along a length of the cylinder 5. The arrangement of flanges depicted in FIG. 1 is not meant to be limiting, and more or fewer flanges 27 can be located along the periphery of the cylinder 5 in various embodiments.

As shown in FIG. 1, at least one O-ring 29 is further disposed at the periphery of the piston 9 to provide an airtight sealing of the piston 9 within the cylinder 5 during the linear sliding of the piston 9.

The through hole 11 of the piston 9 should be sized appropriately based on the desired rate of piston movement within the cylinder 5, since the through hole 11 regulates the amount of air passing through the piston 9. That is, as the size of the through hole 11 increases, the speed of linear sliding of the piston 9 increases.

The air damper 1 thus constructed can be applied to the vehicle glove compartment 15 of FIG. 3.

The air damper 1 preferably is fixed to the main body of the vehicle, and the other end of the string 19 is connected to the cover 17 of the glove compartment 15. As used herein, the cover 17 refers to the front cover of the glove compartment accessed by the user to open and close the glove compartment, and can also include an area for storing personal items in the glove compartment.

The length of the string 19 and a connecting structure of the string 19 with the cover 17 should properly be adjusted and sized according to the opening angle of the cover 17 and the like.

In use, for the glove compartment 15 applied with the above air damper 1, once the user releases the locked state of the glove compartment 15 and opens the cover 17, the cover 17 opens due to gravity, as shown in the dashed lines of FIG. 3, and pulls the string 19, such that the string 19 reaches the extended state depicted in FIG. 3.

During opening of the cover 17, the piston 9 is pulled against the bias of the spring 21, thereby compressing the spring 21, and the piston 9 moves from the initial, extended state of FIG. 2 to the compressed stated depicted in FIG. 1. As the piston 9 moves within the cylinder 3, an air flow occurs through the through hole 11 of the piston 9. The resilient force generated by the compression of the spring 21 and the resistance force generated when the air passes through the through hole 11 are applied to attenuate the opening force of the cover, thereby resulting in a smooth and gentle opening of the cover 17. The air adjusting plate 7 blocks the air adjusting hole 3 to thereby prevent the piston 9 from linearly sliding too fast.

When the user closes the cover 17, the bias of the spring 21 forces the piston 9 toward the distal end of the cylinder 5, and the cover 17 is restored to its position in the initial, extended state of FIG. 2. The air adjusting plate 7 then opens the air adjusting hole 3 in order to allow the piston 9 to easily move within the cylinder 5.

As apparent from the foregoing, the present invention provides significant advantages whereby the cover of the glove compartment is adapted to smoothly and gently open, thereby improving the quality of the vehicle.

Although preferred embodiment(s) of the invention have been described using specific terms, such description is for illustrative purposes only, and it is to be understood that changes and variations may be made without departing from the spirit or scope of the following claims

1. An air damper of a vehicle glove compartment, the air damper comprising:
a cylinder having at one end an air adjusting hole;
an air adjusting plate for adjusting an opening degree of said air adjusting hole according to air flow through said cylinder;
a piston configured to linearly slide in said cylinder, said piston having a through hole at a central portion of said piston;
a string configured to pass through the through hole of said piston, wherein one end of said string includes a head having a larger size than the diameter of said through hole and the other end of said string is connected to a cover of said vehicle glove compartment; and
a spring for resiliently biasing said piston toward said air adjusting hole.

2. The air damper as defined in claim 1, wherein an 0-ring is further provided at a periphery of said piston.

3. The air damper as defined in claim 1, wherein a plurality of flanges are integrally formed at a periphery of said cylinder to fix said cylinder to said vehicle glove compartment.

4. The air damper as defined in claim 1, wherein an adjusting cap is provided at one end of said cylinder to restrict movement of said air adjusting plate and to prevent said air adjusting plate from separating from said cylinder.

5. The air damper as defined in claim 1, wherein a supporting cap is provided at the other end of said cylinder to support said spring within said cylinder and to allow said string to pass through said cylinder.

6. The air damper as defined in claim 1, wherein during opening of the cover of the vehicle glove compartment, the piston is pulled against the bias of the spring, and the piston moves from an extended state to a compressed state in the cylinder.

7. The air damper as defined in claim 6, wherein as the piston moves within the cylinder, air flow occurs through the through hole of the piston.

8. The air damper as defined in claim 1, wherein while closing the cover of the vehicle glove compartment, the bias of the spring forces the piston from a compressed state to an extended state in the cylinder.

9. The air damper as defined in claim 1, further including at least one flange positioned at a distal end of the cylinder.

10. The air damper as defined in claim 1, further including at least one flange positioned along a length of the cylinder.

11. An air damper, comprising:
a cylinder having an air adjusting hole at one end of the cylinder;
an air adjusting plate for at least partially covering the air adjusting hole such that air flow is regulated through the air adjusting hole;
a piston configured to linearly slide in the cylinder, the piston having a through hole at a central portion of the piston;
a string configured to pass through the through hole of the piston, where one end of the string includes a head having a larger size than the diameter of the through hole and the other end of the string is connected to a support; and
a spring for biasing the spring toward the air adjusting hole.

12. The air damper of claim 11, wherein the support constitutes a cover of a glove compartment.

13. The air damper of claim 11, wherein an 0-ring is further provided at a periphery of the piston.

14. The air damper of claim 11, wherein a plurality of flanges are integrally formed at a periphery of the cylinder to fix the cylinder to a glove compartment.

15. The air damper of claim 11, wherein an adjusting cap is provided at one end of said cylinder to restrict movement of the air adjusting plate and to prevent the air adjusting plate from separating from the cylinder.

16. The air damper of claim 11, wherein a supporting cap is provided at the other end of the cylinder to support the spring within the cylinder and to allow the string to pass through the cylinder.

17. The air damper of claim 11, further including at least one flange positioned at a distal end of the cylinder.

18. The air damper of claim 11, further including at least one flange positioned along a length of the cylinder.

19. An air damper for opening and closing a cover of a glove compartment, comprising:
a cylinder having an air adjusting hole at one end of the cylinder;
an air adjusting plate for at least partially covering the air adjusting hole such that air flow is regulated through the air adjusting hole;
a piston configured to linearly slide in the cylinder, the piston having a through hole at a central portion of the piston;
a string configured to pass through the through hole of the piston, where one end of the string includes a head having a larger size than the diameter of the through hole and the other end of the string is connected to the glove compartment; and
a spring for biasing the spring toward the air adjusting hole.

20. The air damper of claim 19, wherein during opening of the cover of the glove compartment, the piston is pulled against the bias of the spring, and the piston moves from an extended state to a compressed state in the cylinder.

21. The air damper of claim 20, wherein as the piston moves within the cylinder, air flow occurs through the through hole of the piston.

22. The air damper of claim 21, wherein while closing the cover of the glove compartment, the bias of the spring forces the piston from a compressed state to an extended state in the cylinder.
